(19) United States
(12) Patent Application Publication
(10) Pub. No.: US 2018/0087729 A1
(43) Pub. Date: Mar. 29, 2018

(54) UNIVERSAL LIGHTING SCONCE

(71) Applicant: Barton L. Garvin, Western Springs, IL (US)

(72) Inventor: Barton L. Garvin, Western Springs, IL (US)

(21) Appl. No.: 15/276,305

(22) Filed: Sep. 26, 2016

(51) Int. Cl. F21S 8/00; F21V 23/00; F21V 17/10; F21V 17/12; F21V 15/01; F21V 19/00

(52) U.S. Cl. CPC F21S 8/033; F21V 23/001; F21V 19/006; F21V 17/12; F21V 15/01; F21V 17/105

(57) ABSTRACT

The present invention is a sconce configured to have a removable mounting plate. The removable mounting plate may be removed from the sconce and swapped with a mounting plate of a different size or geometric profile. The installer of the sconce may choose a mounting plate that matches the existing geometric profile of the existing in-wall junction box and thus has the ability to adapt the single sconce to the necessary environment. In another embodiment of the invention, the sconce is configured to have storage space for additional mounting plates for the convenience of the installer. In another aspect of the invention a method for replacing mounting plates and installing the sconce is disclosed.

### BACKGROUND OF THE INVENTION

The present invention relates generally to temporary universal lighting sconces used during construction or renovation. More particularly, the present invention relates to a wall sconce system that provides for universal fit across a wide array of junction boxes, covers, and device rings and is reusable across multiple constructions sites.

Wall sconces are electrical lighting fixtures designed to be installed and fixed onto a wall. The light from a sconce typically reflects on the wall and lights up the ceiling and surrounding area. A sconce is typically installed at a height of between about 5 to 7 feet above the floor, or about 1.5 to about 2.14 m above the floor, where it can provide adequate light to the ceiling and where it will not obstruct traffic flow or be collided with by people. In construction sites or in retrofit or remodeling sites, hallways will either be rough framed, or the framing will be either fully or partially covered with drywall, paneling, plaster or other wall material. Typically, all pre-existing lighting fixtures are removed during the demolition process in the case of a retrofit or remodeling job or are not yet installed in the case of a new construction job, and temporary lighting must be installed during the construction phase of the job. The universal electrical wall sconce of the present invention is particularly well suited for these types of situations and may be left installed and operational from rough framing, through wall material mounting, through painting, tiling, or wall papering, then removed and replaced with more permanent lighting fixtures.

The installation of a sconce first involves running electrical wires from the power source through the wall to the desired location of the sconce. The wiring is harnessed in a junction box that is installed into the wall and either anchored to the drywall or nearby stud. The junction box serves to harness the electrical wiring as well as provide a support structure to support a mounted sconce. Further, the junction box may or may not have an attached device ring for fixture mounting. Junction boxes and device/fixture mounting rings come in all different shapes and sizes. When installing a new sconce and junction box, it is important to match the mounting plate of the sconce to the shape and size of the junction box and device ring for proper support, to facilitate wall finishing, such as by painting or wall papering, and for aesthetic appeal.

On construction sites or during renovation, temporary sconces are used to provide lighting to installers and builders working inside the living space. These temporary sconces are used at various stages in construction such as new construction prior to the installation of the finished decorative sconce and in remodels to temporarily remove the decorative sconce as to not damage the decorative sconce during the remodel. The temporary sconces for construction used in the prior art come with a mounting plate integrally fixed to the sconce such that the installer needs to bring a temporary sconce that already matches the existing junction box or the new junction box to be installed. This is tedious and cost inefficient because the installer needs to ensure in advance that he has the proper temporary sconce for the job, and depending on the number of jobs and number of sconces required within a job, has to purchase many temporary sconces to potentially match a wide variety of boxes and device ring combinations on the job junction boxes. This results in the installer having to own, store, and bring to a job a large inventory of multiple sconces with multiple mounting plates.

The present invention addresses the issue of uncertainty and inventory control by providing a temporary sconce with the ability to adapt to multiple junction boxes by using swappable mounting plates. The invention also provides for a temporary sconce with the ability to store additional mounting plates to adapt to any junction box as needed.

### SUMMARY OF THE INVENTION

In view of the above, a lighting sconce for use at a construction site or renovation site comprising swappable mounting plates and storage for the swappable mounting plates such that the lighting sconce may be installed and mounted to any of the most common junction boxes is provided.

The advantage of the present invention is that it allows contractors or installers the ability to adapt the lighting sconce to any existing junction box or device ring without having to own a large inventory of sconces with mounting plates of all shapes and sizes or have to look for different mounting stored elsewhere. The contractor is able to keep a lower inventory due to the high adaptability and storage of the lighting sconce.

In one example embodiment of the present invention, the lighting sconce comprises a lighting sconce junction box having at least a first opening configured to receive a light socket and having at least a second opening configured to receive a conduit. A conduit is coupled to the lighting sconce junction box and projects away from the lighting sconce junction box. The conduit is adapted to receive electrical wiring and relay the electrical wiring to the lighting sconce junction box and a light socket. This embodiment further comprises a cover plate removably or movably coupled to the lighting sconce junction box configured to cover a portion of the lighting sconce junction box or open to expose an inside compartment of the lighting sconce junction box. The lighting sconce junction box is further dimensioned to accommodate at least one mounting plate positioned within the inside compartment. Additionally, the at least one mounting plate is adapted to be removably coupled to an end of the conduit opposite the lighting sconce junction box.

In some embodiments, the lighting sconce further comprises at least one divider positioned within the inside compartment configured to divide the inside compartment into at least two compartments. The divider may comprise an internal wall or partial wall, netting, posts, pegs, screws or rods to apportion the inside compartment.

In another example embodiment where the divider is a wall, the divider acts to divide the lighting sconce junction box into at least two separate compartments. At least one of the at least two separate compartments is configured to harness electrical wiring for the light socket and isolate from the second compartment of the at least two separate compartments, while the second compartment is used to store additional mounting plates, tools and/or mounting hardware.

In yet another example embodiment, an elongated member projects from the lighting sconce junction box and is configured such that a mounting plate may be removably coupled thereto for storage of the mounting plate.

In another example embodiment, the lighting sconce junction box and the mounting plate may be configured to removably magnetically engage each other such that the mounting plate may be stored on the inside or outside of the lighting sconce junction box when not in use.

In any of the embodiments discussed above, the lighting sconce may comprise at least one of the following, a light socket coupled to the lighting sconce junction box, a light switch coupled to the lighting sconce junction box and electrically coupled to the light socket, and a light bulb protection shield removably coupled to the lighting sconce junction box disposed over a light socket configured to protect a light bulb.

In another aspect of the invention, a lighting sconce system is provided. The lighting sconce system may comprise any of the embodiments of the light sconce described herein and further comprises a plurality of mounting plates, an in-wall junction box, and electrical wiring configured to electrically couple the light socket or optional switch to an existing electrical supply.

In yet another aspect of the invention, a method is provided for installing the lighting sconce. In an example of the method, an in-wall junction box geometry is identified, a mounting plate with a geometry corresponding to the in-wall junction box geometry is selected. The mounting plate is coupled to a conduit extending from a sconce junction box. The sconce electrical wiring is next inserted through the conduit and into the sconce junction box. The mounting plate is then mounted to the in-wall junction box.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1A is a perspective view of a lighting sconce installed on a wall.

FIG. 1B is an exploded view of the lighting sconce installed on a wall.

FIG. 2 is perspective view of the lighting sconce junction box

FIG. 3 is a perspective view of a lighting sconce with a closed front panel.

FIG. 4A-4D are perspective views of swappable mounting plates.

FIG. 5A-5D are a perspective views of an additional embodiment of the lighting sconce with various divider configurations.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

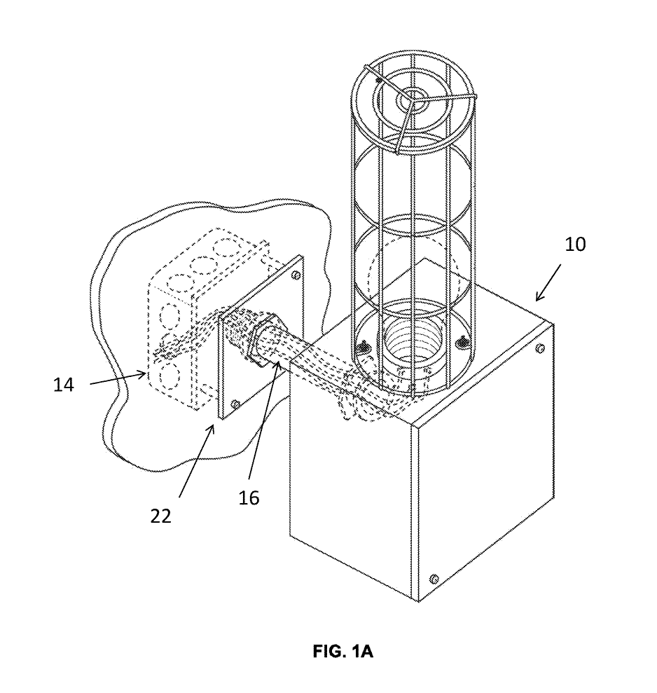

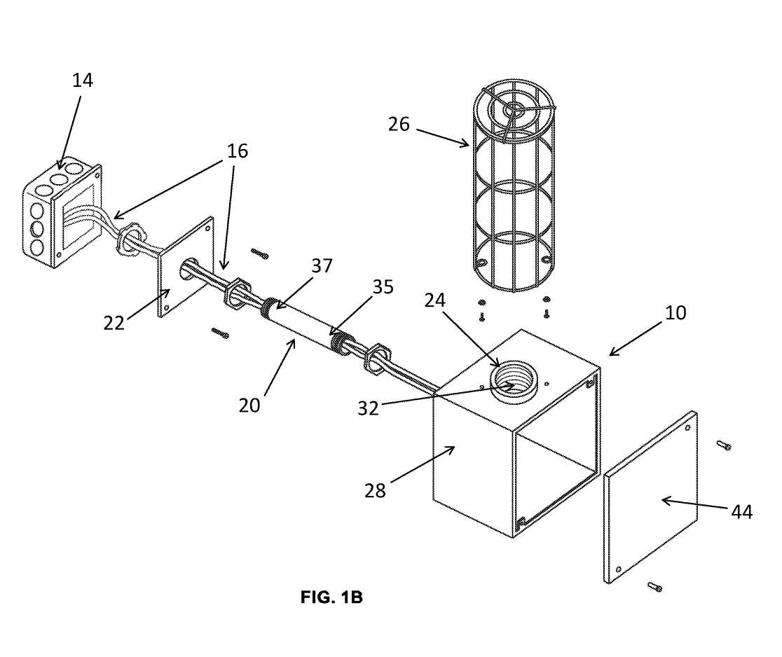

FIG. 1A is a perspective view of the lighting sconce 10 mounted on a wall. FIG. 1B is a perspective exploded assembly view of the lighting sconce 10 mounted on a wall. In addition to the lighting sconce 10, FIG. 1A displays the lighting sconce 10 as installed on a wall with an in-wall junction box 14 electrical wiring 16.

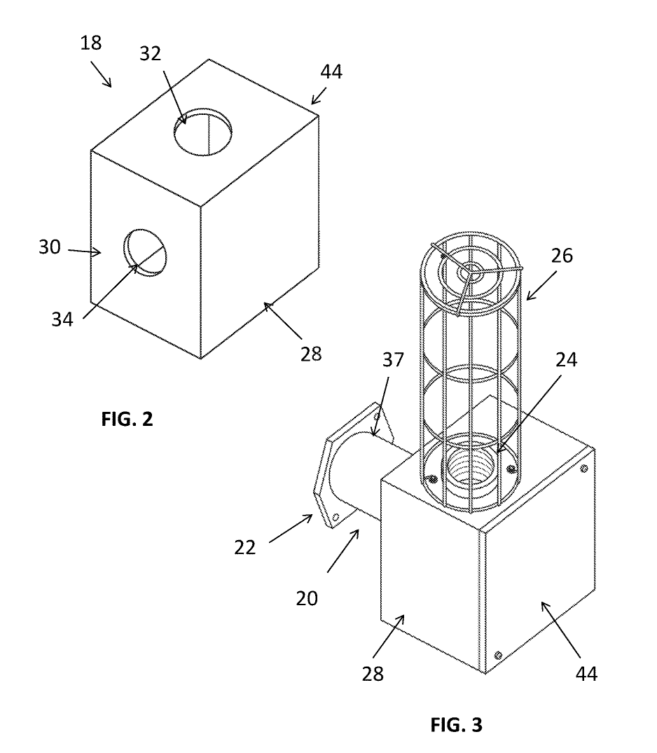

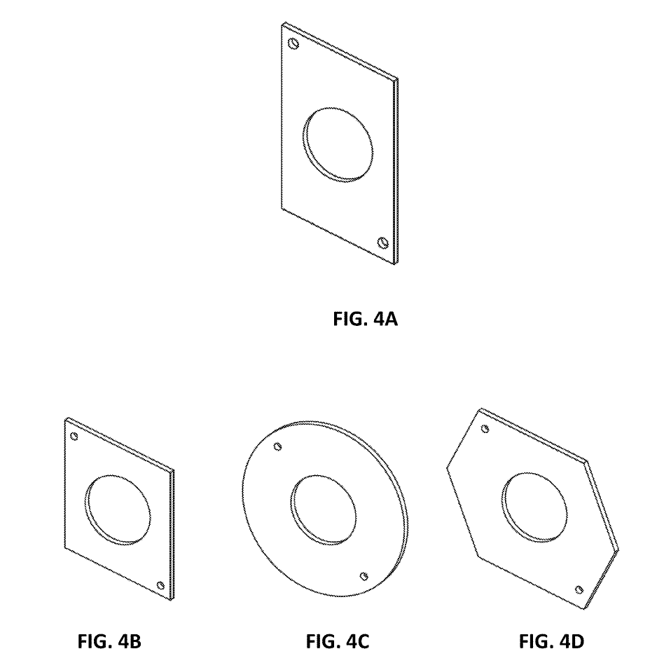

As shown in FIGS. 2-3, the lighting sconce 10 primarily comprises a lighting sconce junction box 18, a conduit 20, and a mounting plate 22. Additional embodiments of the lighting sconce 10 may further comprise a light socket 24, and a lightbulb protection shield 26.

In one embodiment, the lighting sconce junction box 18 comprises an enclosure 28 bound by a base plate 30 and a cover plate 44. The cover plate 44 is removably or moveably coupled to the enclosure 28 to be either completely detachable from the enclosure 28 or at least partially detached from the enclosure 28. An opening 32 is disposed on a top side of the enclosure 28, and a second opening 34 is located is disposed on the base plate 30. The light socket 24 is coupled to the sconce junction box 18 through and coaxially aligned to the first opening 32, while a proximal end 35 of the conduit 20 is coupled to the sconce junction box 18 and aligned coaxially with the second opening 34. The conduit 20 extends away from the base plate 30 and in the opposite direction of the enclosure 28. It is to be understood by one skilled in the art the conduit may comprise an elongated hollowed member with two open ends. Further it is to be understood that the transverse cross-section of the conduit may be shaped as including but not limited to a circle, ellipse, square, rectangle, polygon, or irregular polygon.

The mounting plate 22 is removably coupled to a distal end 37 of the conduit 20. In one embodiment the mounting plate 22 may be removably coupled by complimentary threading on the distal end 37 of the conduit 20 and a through-hole on the mounting plate 22. It is to be understood by one skilled in the art that other attachment and detachment mechanisms may be implemented to add and remove the mounting plate 22 including but not limited to snaps, frictional fitting, magnets, and fasteners.

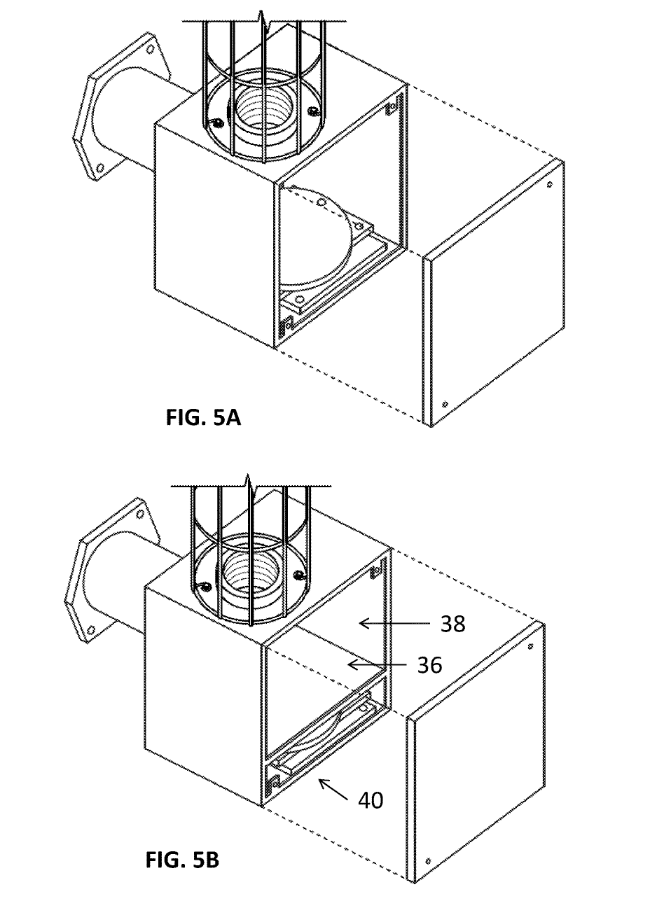

Because the mounting plate 22 is removably coupled to the elongated member 26, different variations and geometries of mounting plates 22 may be swapped out to accommodate the geometry of the in-wall junction box 14. By way of example and not meant to limit the geometries of possible mounting plates 22, FIGS. 4-4D show common geometries of mounting plates 22, such as rectangular, square, circular, and octagonal designed to match common geometries of in-wall junction boxes 14.

In some embodiments, a lightbulb shield member 26 is coupled to the sconce junction box 18 to protect the lightbulb from damage. The shield member 26 may be coupled through common fasteners through the sconce junction box 18, or magnetically coupled to the sconce junction box 18, for quick removal to change a bulb or to remove the bulb and store for use at a later time.

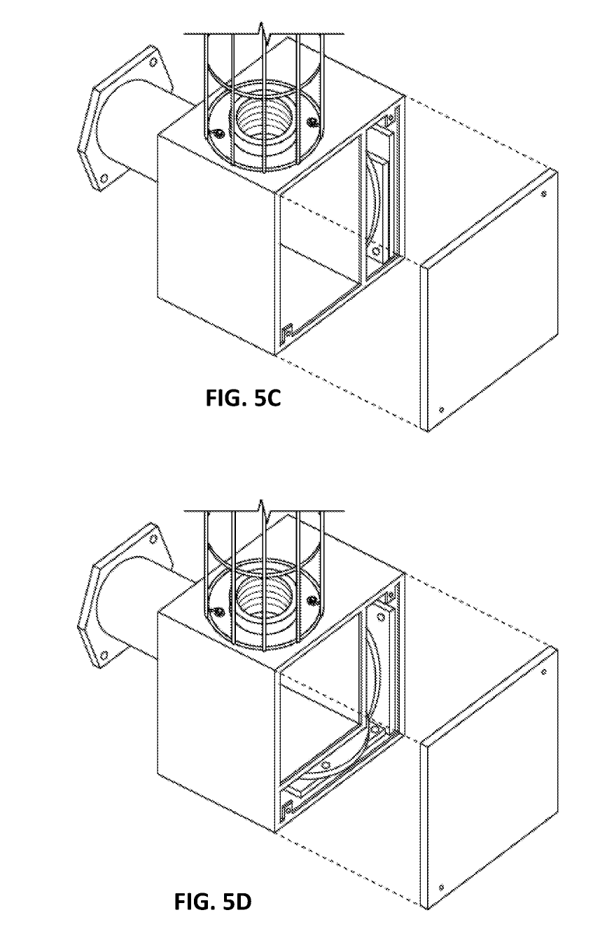

In another embodiment, the sconce 10 comprises an enlarged sconce junction box 18 to provide storage of additional components. For example, in one embodiment, the sconce junction box 18 may be used to store extra mounting plates 22 of varying geometries. In this embodiment, the height, depth, and width of the sconce junction box 18 must be made sufficiently large to accommodate the size of a common mounting plate 22. FIG. 5A shows a sconce 10 with an enlarged sconce junction box 18 such that at least one extra mounting plate 22 can be stored for convenience.

In some embodiments a divider is used to divide the inside compartment such that the extra mounting plates 22 can be organized and separated from the electrical wiring of the socket. The divider may include for example but not limited to an internal wall extending from base plate 30, netting coupled to the inside of the sconce junction box 18, metal cut-outs or projections of the sconce junction box 18 folded or formed into the internal compartment, insert molded plastic, screws or rod extending into the compartment or through the internal compartment.

FIGS. 5B-D show additional embodiments in which an interior wall 36 extends perpendicularly from the base plate 30 such that it divides the interior of the sconce junction box into two compartments, a first compartment 38 and a second compartment 40. The first compartment 38 is configured to house the light socket 24 and the electrical wiring 16 that comes through the second through-hole 34 that is coupled to the light socket 24. The first compartment 38 is further configured to be isolated from the second compartment 40. The second compartment is configured to be used for the storage of additional mounting plates 22 or additional mounting hardware 42 such as screws, bolts, anchors, tools, and washers. In additional embodiments, as shown by way of example in FIG. 5D the sconce junction box 18 may comprise multiple interior walls 36 to form multiple storage compartments.

In additional embodiments of the sconce 10 the sconce junction box 18 comprises a cover plate 44 coupled to the sconce junction box 18 configured to be opened, closed, or removed from the junction box 18. In one embodiment the cover plate 44 is hinged onto a portion of the enclosure 28 such that it is permanently attached, but configured to rotate open and closed. The cover plate 44 may be held in place by the preload force of the hinge, or held into place by matting features, such as a magnet or fastener on the opposite side of the enclosure 28. In another embodiment, the cover plate 44 may be secured by known fastening methods in the art including but not limited to magnets, screws, or snaps.

In yet another example embodiment, an elongated member projects from the lighting sconce junction box and is configured such that a mounting plate may be removably coupled thereto for storage of the mounting plate. In this embodiment the mounting plate may be coupled by coupling means known in the art including but not limited to complimentary threading, snaps, fasteners, and magnets.

In another example embodiment, the lighting sconce junction box and the mounting plate may be configured to removably magnetically engage each other such that the mounting plate may be stored on the inside or outside of the lighting sconce junction box when not in use. In this configuration, the sconce junction box may comprise a magnetically engageable surface or may comprise separate magnets fixed to or embedded within the surface. Likewise, the mounting plates may comprise an magnetically engageable surface or may comprise separate magnets fixed to or embedded with the surface.

In any of the embodiments discussed above, the lighting sconce may comprise at least one of the following, a light socket coupled to the lighting sconce junction box, a light switch coupled to the lighting sconce junction box and electrically coupled to the light socket, and a light bulb protection shield removably coupled to the lighting sconce junction box disposed over a light socket configured to protect a light bulb.

The components of such as the sconce junction box 18, cover plate 44, conduit 20, and mounting plates 22 may be comprised of materials in the industry including but not limited to metals such as steel, stainless steel, or galvanized steel, aluminum or polymers such as ABS, fiberglass, polycarbonate or polystyrene.

Another aspect of the invention comprises a method of using any of the embodiments discussed above. An example of this method includes first identifying the geometry of the in-wall junction box 14 in which the sconce 10 will mounted to. Once the in-wall junction box 14 geometry is identified, the mounting plate 22 with geometry corresponding to the in-wall junction box 14 may be selected. In some embodiments, the cover 44 of the sconce junction box 18 is opened, and the mounting plate 22 is chosen from a selection of mounting plates 22 stored within the sconce junction box 18. After the appropriate mounting plate 22 is selected, the mounting plate 22 is coupled to the distal end 37 of conduit 20. After the mounting plate 22 is coupled to the conduit 20, the electrical wiring 16 can be run through the conduit 20 and the sconce 10 can be mounted via the mounting plate 22 onto the in-wall junction box 14.

In some embodiments the mounting plate 22 is threaded onto the distal end 37 of the conduit 20. In some embodiments, a preexisting mounting plate 22 will need to be decoupled from the elongated tube member 26 before coupling the mounting plate 22 with the appropriate geometry. Additionally in some embodiments, the preexisting mounting plate 22 that was just removed may be stored in the sconce junction box 18.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1. A lighting sconce comprising:
a lighting sconce junction box having at least a first opening configured to receive a light socket and having at least a second opening configured to receive a conduit;
the conduit coupled to the lighting sconce junction box and projecting away from the lighting sconce junction box, adapted to receive electrical wiring and relay the electrical wiring to the lighting sconce junction box and the light socket;
a cover plate removably or movably coupled to the lighting sconce junction box configured to cover a portion of the lighting sconce junction box or open to expose an internal compartment of the lighting sconce junction box;
the lighting sconce junction box further dimensioned to accommodate at least one mounting plate positioned within the inside compartment; and
the at least one mounting plate adapted to be removably coupled to an end of the conduit opposite the lighting sconce junction box.

2. The lighting sconce of claim 1 further comprising at least one divider positioned within the inside compartment configured to divide the inside compartment into at least two compartments.

3. The lighting sconce of claim 2 wherein at least a first compartment of the at least two compartments is dimensioned to accommodate the at least one mounting plate positioned within the first compartment.

4. The lighting sconce of claim 2 wherein the at least one divider comprises at least one of the following coupled to the inside of the lighting sconce junction box, metal cut-outs or projections of the lighting sconce junction box folded or formed into the internal compartment, insert molded plastic, screws or rods extending into the internal compartment or through the internal compartment.

5. The lighting sconce of claim 2 wherein the at least one divider comprises a wall or partial wall.

6. The lighting sconce of claim 5 wherein a first compartment of the at least two compartments is configured to isolate electrical wiring from a second compartment of the at least two compartments, and the second compartment is configured to accommodate the at least one mounting plate positioned within the second compartment.

7. The lighting sconce of claim 1 wherein the cover plate is removably or movably coupled to the lighting sconce junction box by any one of the following, at least one screw, a hinge, at least one magnet, at least one fastener, or at least one snap.

8. The lighting sconce of claim 1 wherein the lighting sconce junction box, the conduit, and the mounting plate are comprised of a material including at least the following: steel, stainless steel, galvanized steel, aluminum, ABS, fiberglass, polycarbonate or polystyrene.

9. The lighting sconce of claim 1 adapted such that the mounting plate may be magnetically engaged to the lighting sconce junction box or the conduit.

10. The lighting sconce of claim 1 wherein the at least one mounting plate comprises a geometric profile of a square, rectangle, circle, ellipse, polygon, or irregular polygon.

11. The lighting sconce of claim 1 wherein the at least one mounting plate comprises a threaded opening configured to removably couple the at least one mounting plate to the conduit.

12. The lighting sconce of claim 1 further comprising a member coupled to the lighting sconce junction box and projecting away from the lighting sconce junction box wherein the mounting plate is further adapted to be removably coupled to an end of the member opposite the lighting sconce junction box.

13. The lighting sconce of claim 1 further comprising a light socket coupled to the lighting sconce junction box disposed through the at least first opening configured to receive a light socket.

14. The lighting sconce of claim 13 further comprising a light switch coupled to the lighting sconce junction box configured to be electrically coupled to the light socket.

15. The lighting sconce of claim 13 further comprising a light bulb protection shield removably coupled to the lighting sconce junction box disposed over the light socket.

16. A lighting sconce system wherein:
A lighting sconce comprises lighting sconce junction box having at least a first opening configured to receive a light socket and having at least a second opening configured to receive a conduit;
the conduit coupled to the lighting sconce junction box and projecting away from the lighting sconce junction box, adapted to receive electrical wiring and relay the electrical wiring to the lighting sconce junction box and the light socket;
a cover plate removably or movably coupled to the lighting sconce junction box configured to cover a portion of the lighting sconce junction box or open to expose an inside compartment of the lighting sconce junction box;
the lighting sconce junction box further dimensioned to accommodate at least one mounting plate positioned within the inside compartment;
the at least one mounting plate adapted to be removably coupled to an end of the conduit opposite the lighting sconce junction box; and
the at least one mounting plate further adapted to removably couple the lighting sconce to an in-wall junction box.

17. A method of installing a lighting sconce onto a wall comprising:
a) identifying an in-wall junction box geometry;
b) removing or moving a cover plate of the lighting sconce to reveal an internal compartment of the lighting sconce storing at least one mounting plate;
b) selecting a mounting plate from the at least one mounting plate with complimentary geometry to the in-wall junction box geometry;
c) removably coupling the mounting plate to the lighting sconce; and
d) mounting the lighting sconce via the mounting plate to the in-wall junction box.
